(19) United States
(12) Patent Application Publication
(10) Pub. No.: US 2018/0099358 A1
(43) Pub. Date: Apr. 12, 2018

(54) Metallic Sleeve For Reducing Distortion In Additive Manufacturing

(71) Applicant: General Electric Company, Schenectady, NY (US)

(72) Inventors: Kassy Moy Hart, Greenville, SC (US); David Edward Schick, Simpsonville, SC (US)

(21) Appl. No.: 15/288,069

(22) Filed: Oct. 7, 2016

(51) Int. Cl. B23K 26/342; B33Y 10/00; B33Y 30/00; B33Y 50/02; B23K 15/00; B23K 26/70

(52) U.S. Cl. CPC B23K 26/342; B33Y 10/00; B23K 26/702; B33Y 50/02; B23K 15/0086; B33Y 30/00

(57) ABSTRACT

A method of manufacturing a metal object by selective melting of a metal powder is provided. The method includes forming the metal object layer by layer in a metal powder bed on a retractable build platform. During the forming, a metal sleeve is provided spaced apart from and substantially paralleling an outer surface of the metal object, the metal sleeve being separated from the metal object by a gap filled with non-melted metal powder. The metal sleeve reduces thermal distortions in the object. An additive manufacturing system that includes a metallic sleeve that surrounds the metal object as it is formed is also disclosed.

### BACKGROUND OF THE INVENTION

The disclosure relates generally to additive manufacturing, and more particularly, to a thermal gradient dissipation structure in the form of a metallic sleeve spaced apart and around a metallic object for reducing distortion thereof.

Additive manufacturing includes producing an object through layering of material rather than the removal of matter from a material block. Additive manufacturing, also known in the art as “3D printing,” can reduce manufacturing costs by allowing objects to be formed more quickly, with unit-to-unit variations as appropriate, through direct application of computer-generated models and with less expensive equipment and/or raw materials. In one approach, additive manufacturing creates an object from a bed of fine metal powder positioned on a build platform. An electron beam or laser (e.g., using heat treatments such as sintering) is used to form sequential layers of an object in the metal powder. After each layer is formed, the build platform can be lowered by the thickness of one layer, and a new layer of metal powder is spread across the previously formed layers. The process repeats until the object is complete. Two forms of this AM process are referred to as direct metal laser melting (DMLM) and selective laser melting (SLM). Additive manufacturing equipment can form objects by using three-dimensional models generated with software included within and/or external to the manufacturing equipment. Some devices fabricated via additive manufacturing can be formed initially as several distinct objects at respective processing stages before being assembled in a subsequent process.

Additive manufacturing is also advantageous to create thin objects, e.g., with wall thicknesses of 0.1 to 5.0 millimeters. One challenge with thin walled objects is that thermal gradients within the object cause stresses that result in distortions in the object. This issue is especially challenging relative to tall, thin objects. More particularly, as tall thin objects are generated, layer by layer, on a heated build platform, the thermal gradient is larger at the bottom than the top of the object. Since the thinner areas cool faster, the temperature gradient is increased at the later formed layers and the object warps or otherwise deforms.

There are a number of known approaches that attempt to address thermal gradients in metal powder additive manufacturing of tall, thin objects. One common solution is to simply make the objects with thicker walls, and machine them to the desired thickness. Machining, however, is time consuming and expensive, and can result in mis-shapened areas on the object and other forms of defects. Another approach applies cooling passages in the metal powder bed near where the object being formed. This approach adds complexity to the manufacturing process and does not accurately provide cooling where it is required—in close proximity to the object being built. It is also known to provide structures in close proximity along only a portion of the object to provide support, e.g., along a curve of an airfoil or under an overhang. Such support structures do not provide uniform thermal dissipation to the entire object, and thus do not address deformation in all of the object. It is also known to provide support structures that couple to the object, or are formed with the object, to prevent deformation. An issue with this approach is that the support structures must be removed later, which adds to the machining costs and time. Another issue with this approach is that the support structures connected to the object can also create unforeseen thermal gradients, further complicating control of stresses in the object.

### BRIEF DESCRIPTION OF THE INVENTION

A first aspect of the disclosure provides a method of manufacturing a metal object by selective melting of a metal powder, the method comprising: forming the metal object layer by layer in a metal powder bed on a retractable build platform; and during the forming, providing a metal sleeve spaced apart from and substantially paralleling an outer surface of the metal object, the metal sleeve being separated from the metal object by a gap filled with non-melted metal powder.

A second aspect of the disclosure provides a metal powder additive manufacturing system for creating a metal object, the system comprising: a build platform to receive successive layers of metal powder and support the metal object during manufacture; an applicator to create a layer of metal powder over the build platform; an electron or laser beam transmitter operative to form the metal object layer by layer by selectively melting the successive layers of metal powder over the build platform; and a control system for controlling at least movement between the build platform, the electron or laser beam transmitter and the applicator; and a metal sleeve extending through a slot in the build platform and having an interior surface configured to substantially parallel an outer surface of the metal object as the metal object is formed within the metal sleeve.

A third aspect provides a non-transitory computer readable storage medium storing code representative of a metal object and a metal thermal gradient dissipating structure, the metal object and the metal thermal dissipating structure physically generated upon execution of the code by a computerized metal powder additive manufacturing system, the code comprising: code representing the object and the thermal dissipating structure, the thermal dissipating structure including: a metal sleeve spaced apart from and substantially paralleling an outer surface of the metal object.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a block diagram of an additive manufacturing system including a non-transitory computer readable storage medium storing code representative of an object according to embodiments of the disclosure.

FIG. 2 shows a perspective view of a metal sleeve spaced apart from an object as built according to embodiments of the disclosure.

FIG. 3 shows a perspective view of a metal sleeve spaced apart from an object as built according to another embodiment of the disclosure.

FIG. 4 shows a perspective view of a metal sleeve spaced apart from an object as built according to another embodiment of the disclosure.

FIG. 5 shows a cross-sectional view of parts of an AM printer including a metal sleeve according to embodiments of the disclosure.

FIG. 6 shows a cross-sectional view of parts of an AM printer including a metal sleeve according to another embodiment of the disclosure.

FIGS. 7-9 show cross-sectional view of a small number of examples of shapes of a metal sleeve according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

Embodiments of the disclosure provide for forming of a metal object using a metal thermal gradient dissipating structure in the form of a metal sleeve about the metal object.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s). “Substantially” as applied herein indicates within the extent in which functionality would not be unnecessarily hindered, e.g., “substantially parallel” indicates parallel or at least parallel to the extent that opposing surfaces would not intersect.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or objects, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

As used herein, additive manufacturing (AM) may include any process of producing an object through the successive layering of material using metal powder. As known, additive manufacturing can create complex geometries without the use of any sort of tools, molds or fixtures, and with little or no waste material. Instead of machining objects from solid billets of plastic or metal, much of which is cut away and discarded, the only material used in additive manufacturing is what is required to shape the object. Additive manufacturing processes as used herein may include any metal powder format such as but not limited to: selective laser melting (SLM) and direct metal laser melting (DMLM).

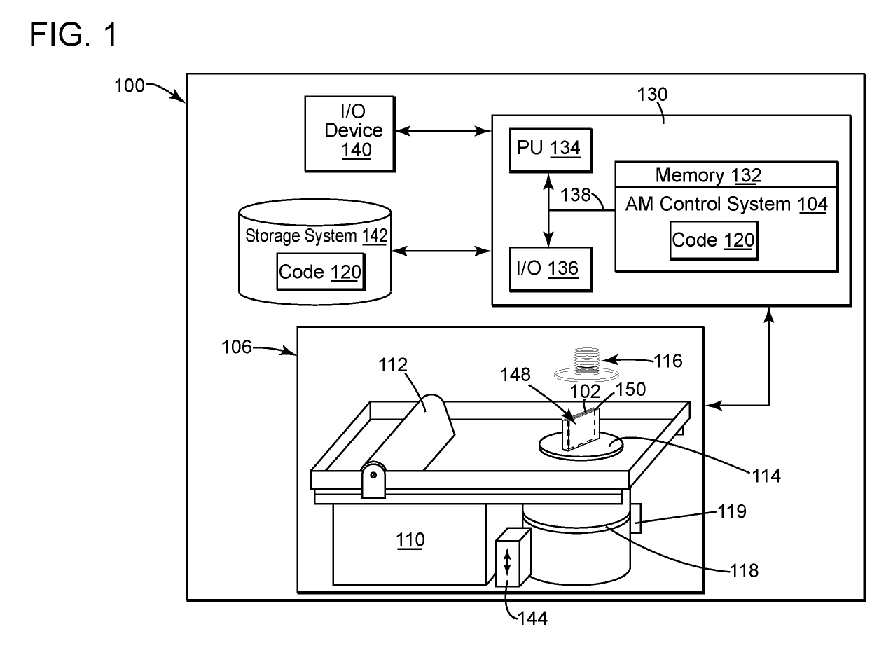

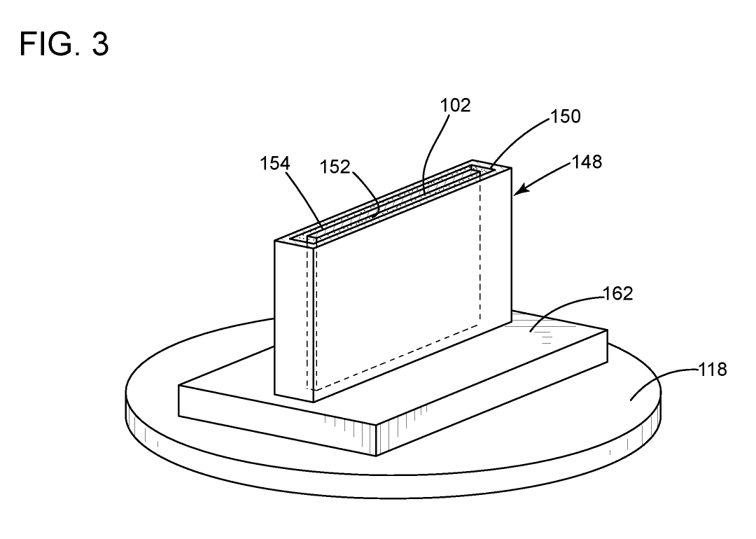

To illustrate an example of an additive manufacturing process according to one embodiment of the disclosure, FIG. 1 shows a schematic/block view of an illustrative computerized additive manufacturing system 100 for generating a metal object 102 (hereinafter simply “object 102”). In FIGS. 1-3, object 102 is illustrated as a tall, thin walled object; however, it is understood that the teachings of the disclosure can be readily adapted to any object having a portion that includes a thin wall. As used herein, “thin wall” means having a wall thicknesses of 0.1 to 5.0 millimeters, and “tall” means having at least a portion having a height that is a multiple of a width of the object greater than 8. Although described herein mostly as a freestanding entity, it is emphasized that object 102 may be, in some embodiments, a portion of a larger entity, e.g., it can be an upstanding wall on a wider entity (see FIG. 3). Also shown in FIGS. 1-3 is a metal thermal gradient dissipating structure 148 including a metal sleeve 150 used according to embodiments of the disclosure, as will be described.

In this example, system 100 is arranged for DMLM. It is understood that the general teachings of the disclosure are equally applicable to other forms of metal powder additive manufacturing. AM system 100 generally includes a computerized additive manufacturing (AM) control system 104 and an AM printer 106. AM system 100, as will be described, executes code 120 that includes a set of computer-executable instructions defining object 102 to physically generate the object using AM printer 106. In the example shown, the AM process uses fine-grain metal powder, a stock of which may be held in a chamber 110 of AM printer 106. In the instant case, object 102 may be made of any now known or later developed metal or metal alloy capable of being used in a metal powder based AM printer.

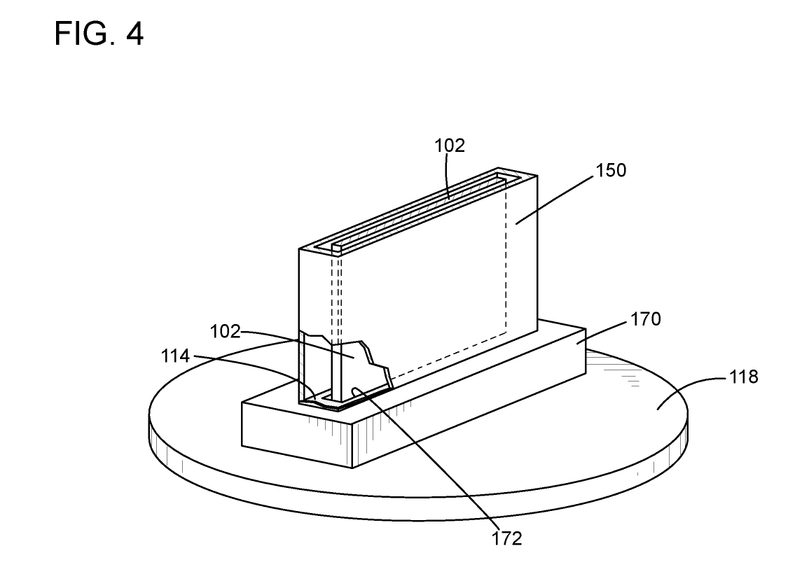

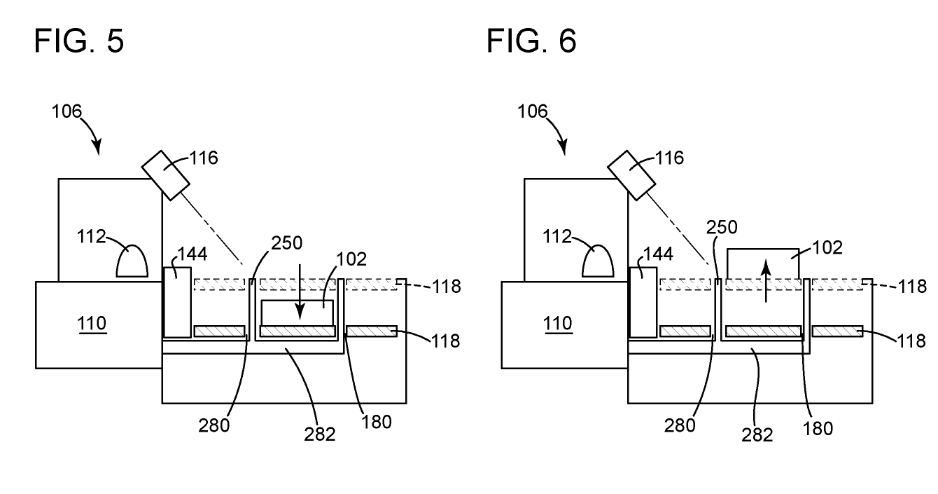

As illustrated, a build platform 118 receives successive layers 114 of metal powder and supports object 102 during manufacture. Build platform 118 may be heated in any now known or later developed manner, e.g., using heating element 119 coupled thereto controlled by control system 104. An applicator 112 creates a (thin) layer of metal powder 114 over build platform 118, i.e., spread out as the blank canvas over build platform 118 from a metal powder holding chamber 110, from which each successive slice of the final object will be created. In the example shown, a laser or electron beam transmitter 116 is operative to form object 102 layer by layer by selectively melting the successive layers of metal powder over build platform 118, i.e., by fusing particles for each slice, as defined by code 120. Various parts of AM printer 106 may move by way of an actuator 144 to accommodate the addition of each new layer. For example, a build platform 118 may retract/lower relative to applicator 112 and other parts (see FIG. 5), and/or at least laser or electron beam transmitter 116 and applicator 112 may rise relative to build platform 118 (see FIG. 4), after each layer.

AM control system 104 controls operation of laser or electron beam transmitter 116. AM control system 104 also controls actuator 144 that controls movement between build platform 118, laser or electron beam transmitter 116 and applicator 112. AM control system 104 is shown implemented on computer 130 as computer program code. To this extent, computer 130 is shown including a memory 132, a processor 134, an input/output (I/O) interface 136, and a bus 138. Further, computer 130 is shown in communication with an external I/O device/resource 140 and a storage system 142. In general, processor 134 executes computer program code, such as AM control system 104, that is stored in memory 132 and/or storage system 142 under instructions from code 120 representative of object 102. While executing computer program code, processor 134 can read and/or write data to/from memory 132, storage system 142, I/O device 140 and/or AM printer 106. Bus 138 provides a communication link between each of the components in computer 130, and I/O device 140 can comprise any device that enables a user to interact with computer 140 (e.g., keyboard, pointing device, display, etc.). Computer 130 is only representative of various possible combinations of hardware and software. For example, processor 134 may comprise a single processing unit, or be distributed across one or more processing units in one or more locations, e.g., on a client and server. Similarly, memory 132 and/or storage system 142 may reside at one or more physical locations. Memory 132 and/or storage system 142 can comprise any combination of various types of non-transitory computer readable storage medium including magnetic media, optical media, random access memory (RAM), read only memory (ROM), etc. Computer 130 can comprise any type of computing device such as a network server, a desktop computer, a laptop, a handheld device, a mobile phone, a pager, a personal data assistant, etc.

Additive manufacturing processes begin with a non-transitory computer readable storage medium (e.g., memory 132, storage system 142, etc.) storing code 120 representative of object 102. As noted, code 120 includes a set of computer-executable instructions defining object 102 that can be used to physically generate the object, upon execution of the code by system 100. For example, code 120 may include a precisely defined 3D model of object 102 and can be generated from any of a large variety of well known computer aided design (CAD) software systems such as AutoCAD®, TurboCAD®, DesignCAD 3D Max, etc. In this regard, code 120 can take any now known or later developed file format. For example, code 120 may be in the Standard Tessellation Language (STL) which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 120 may be translated between different formats, converted into a set of data signals and transmitted, received as a set of data signals and converted to code, stored, etc., as necessary. Code 120 may be an input to system 100 and may come from an object designer, an intellectual property (IP) provider, a design company, the operator or owner of system 100, or from other sources. In any event, AM control system 104 executes code 120, dividing object 102 into a series of thin slices that it assembles using AM printer 106 in successive layers of liquid, powder, sheet or other material. In the DMLM example, each layer is melted to the exact geometry defined by code 120 and fused to the preceding layer. Subsequent to completion of additive manufacture, object 102 may be exposed to any variety of finishing processes, e.g., minor machining, sealing, polishing, assembly to another object, etc.

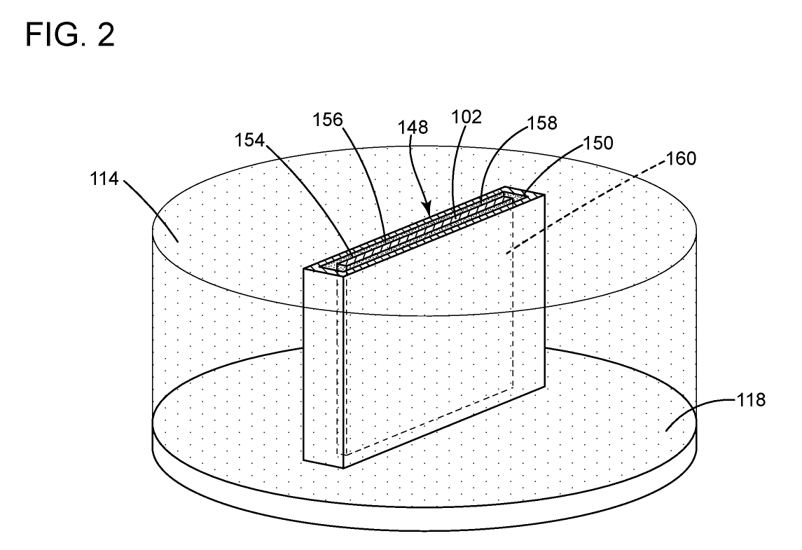

With continuing reference to FIG. 1 and additional reference to FIGS. 2-9, a method of manufacturing object 102 by selective melting of metal powder layers 114 according to embodiments of the disclosure will now be described. According to embodiments of the disclosure, object 102 is formed layer by layer over build platform 118, i.e., under control of control system 104. The selective melting of metal powder 114 may include using one of an electron beam and a laser beam, as noted herein. Further, build platform 118 may be heated during formation and/or during subsequent processing. In contrast to conventional metal powder AM processes, however, as shown in FIG. 1 and more particularly in FIG. 2, embodiments of the disclosure provide a metal thermal gradient dissipating structure 148 in the form of a metal sleeve 150 spaced apart from and substantially paralleling an outer surface 152 of object 102. As shown best in FIG. 2, metal sleeve 150 is separated from object 102 by a gap 154 filled with non-melted metal powder 156, i.e., during forming of object 102 and when completed. An interior surface 158 of metal sleeve 150 may be spaced apart from outer surface 160 of object 102 by a distance of greater than 0.1 millimeters and less than 5.0 millimeters, so as to envelope or surround object 102. The spacing may be determined based on a number of factors that control thermal gradient dissipation and/or deformation of object 102, such as but not limited to: the type of deformation being addressed, the thickness of object 102, other objects being formed simultaneously with object 102, the type of metal powder, and the type/temperature of the beam used. Typically, the thicker the object 102, the larger gap 154 can be. During the forming of object 102, and in any subsequent annealing processes, metal sleeve 150 acts to provide uniform thermal dissipation of heat from object 102, thus reducing thermal gradients that cause stress and the resulting deformations such as warping of other distortions or damage, typically experienced during cooling. Metal sleeve 150 also allows object 102 to be formed without altering its geometry. Further, with no interconnected supports to object 102, post-manufacture machining operations to remove the supports is eliminated.

Metal sleeve 150 can be provided in a number of ways according to embodiments of the disclosure. In one embodiment, shown in FIG. 2, metal sleeve 150 is simultaneously formed with object 102 layer by layer over build platform 118. In this case, thermal gradient dissipating structure 148 in the form of metal sleeve 150 is incorporated in code 120. That is, code 120 includes a set of computer-executable instructions defining object 102 and metal thermal gradient dissipating structure 148, i.e., metal sleeve 150, that can be used to physically generate the object and the metal sleeve, upon execution of code 120 by system 100. For example, code 120 may include a precisely defined 3D model of object 102 and metal sleeve 150, and can be generated from any of aforementioned CAD software and take on any of the aforementioned file formats. As object 102 grows, metal sleeve 150 mass also grows, adding mass to the build and reducing the thermal gradient across object 102. Once object 102 is formed, object 102 and metal sleeve 150 may be removed from build platform 118 in any now known or later developed manner, e.g., wire cutting. Where appropriate, metal sleeve 150 may be reduced to metal powder, e.g., by pulverizing, and reused. In some cases, it may also be possible to use metal sleeve 150 for purposes as described herein, and also as an object itself. Metal sleeve 150 formed according to this embodiment includes the same material as object 102. As shown in FIG. 3, although described herein mostly as a freestanding entity, it is emphasized that object 102 may be, in some embodiments, a portion of a larger entity 162, e.g., it can be an upstanding wall on a wider entity (see FIG. 3), and metal sleeve 150 provided only where necessary.

Referring to FIG. 4, where metal sleeve 150 is formed with object 102, in an alternative embodiment, metal sleeve 150 may be formed on a support structure 170 on build platform 118. Support structure 170 may include any manner of structure on build platform 118 that can support metal sleeve 150 and allow for object 102 (or other structure connected thereto) to otherwise be formed. In the example shown, support structure 170 may include a rectangular structure having an opening 172 having dimensions large enough that metal powder 114 can be received therein and object 102 can be formed in opening 172, but small enough that metal sleeve 150 is supported along opening 172 in spaced apart and parallel fashion to object 102. As will be apparent, metal sleeve 150 and opening 172 can take a large variety of alternative shapes. With this embodiment, when object 102 is complete, metal sleeve 150 can be removed for inspection or powder removal, e.g., prior to heat treatment of object 102 in place.

FIGS. 5 and 6 show a partial cross-sectional view of selected parts of an AM printer 106 (i.e., build platform 118, applicator 112, beam transmitter 116, metal powder chamber 110, actuator 119, metal sleeve 150) according to another embodiment. In this embodiment, AM system 100 (FIG. 1) is modified to accommodate a preexisting metal sleeve 250 configured for a particular object 102. That is, metal sleeve 150 is not printed with object 102, but constitutes part of AM system 100, and is sized and shaped to accommodate a particular object 102 to be printed by AM system 100. As shown in FIGS. 5 and 6, in this embodiment, build platform 118 may be provided with a slot 280 configured to permit metal sleeve 250 to move therethrough during forming of object 102. That is, metal sleeve 250 extends through slot 280 in build platform 118 and, as with metal sleeve 150 shown in FIG. 2, has an interior surface 158 configured to substantially parallel an outer surface 160 of object 102 as object 102 is formed within metal sleeve 250.

Metal sleeve 250 is immovably positioned to pass through slot 180 of build platform 118 and to retain a spacing (i.e., gap 154 in FIG. 2) of metal sleeve 250 with object 102 as the latter is formed. As described previously, metal sleeve 250 may be spaced apart from outer surface 158 (FIG. 2) of object 102 by a distance of, for example, greater than 0.1 millimeters and less than 5.0 millimeters. Metal sleeve 250 may be immovably positioned in any now known or later developed fashion. In FIGS. 5 and 6, metal sleeve 150 is immovably positioned by mechanical couplings 282 to applicator 112 (e.g., via chamber 110). FIG. 5 shows an embodiment in which actuator 144 lowers build platform 118 relative to applicator 112, and FIG. 6 shows an embodiment in which actuator 144 raises at least applicator 112 (and perhaps beam transmitter 116, chamber 110, etc.) relative to build platform 118. Actuator 144 may include any now known or later developed form of actuator and actuator framework for moving build platform 118 relative to applicator 112, etc., to allow for operation of AM printer 106. In any event, as object 102 is formed, metal sleeve 250 remains adjacent thereto as each layer is formed, i.e., by relative movement of build platform 118 relative to applicator 112, etc. In this embodiment, metal sleeve 250 may include the same material as object 102, but advantageously may include a metal with high thermal conductivity such as but not limited to stainless steel, nickel based alloys, cobalt chrome, Inconel 625, and Inconel 718. To enlarge the capabilities of any given AM system relative to this embodiment, metal sleeve 250 may include a plurality of metal sleeves, i.e., a set, each having at least one of a different shape, thickness and height, to accommodate forming of different objects 102. A number of build platforms 118 having different shaped slots 180 to accommodate the different metal sleeves 250 may also be provided.

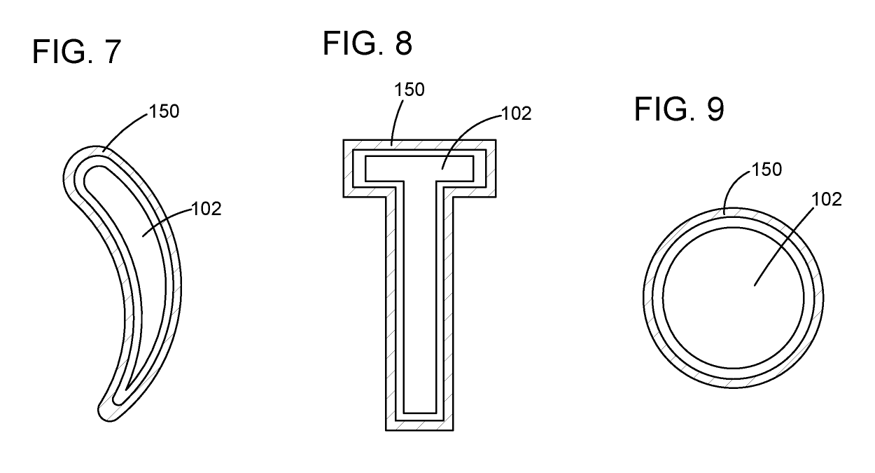

With reference to FIGS. 7-9, while one shape of metal sleeve 150, 250 has been illustrated, it is emphasized that metal sleeve 150, 250 can take any shape necessary to accommodate different sized and shaped objects 102, some examples of which are shown in the cross-sectional views of FIGS. 7-9. FIG. 7 shows an airfoil shape, FIG. 8 shows a T-shape, and FIG. 9 shows a circular shape. Practically any shape is possible.

Regardless of the embodiment employed, by providing a metal sleeve 150, 250 around the intended flat/thin object 102, the thermal gradient changes. In particular, metal sleeve 150, 250 acts as a barrier to keep heat in as object 102 builds, allowing for more even cooling over the entire process, reducing thermal stresses and mitigating object distortion.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method of manufacturing a metal object by selective melting of a metal powder, the method comprising:
forming the metal object layer by layer over a build platform; and
during the forming, providing a metal sleeve spaced apart from and substantially paralleling an outer surface of the metal object, the metal sleeve being separated from the metal object by a gap filled with non-melted metal powder.

2. The method of claim 1, wherein an interior surface of the metal sleeve is spaced apart from the outer surface of the metal object by a distance of greater than 0.1 millimeters and less than 5.0 millimeters.

3. The method of claim 1, wherein the metal sleeve providing the metal sleeve includes simultaneously forming the metal sleeve with the metal object layer by layer over the build platform.

4. The method of claim 3, wherein the metal sleeve providing includes forming the metal sleeve on a support structure on the build platform.

5. The method of clam 4, further comprising separating the metal object from the build platform and the metal sleeve from the build platform.

6. The method of claim 1, wherein the metal sleeve providing includes:
providing the build platform with a slot configured to permit the metal sleeve to move therethrough during the forming of the metal object; and
immovably positioning the metal sleeve to pass through the slot in the build platform and to retain a spacing of the metal sleeve with the metal object during the forming.

7. The method of claim 1, wherein the forming includes selectively melting the metal powder using one of an electron beam and a laser beam.

8. The method of claim 1, wherein the metal object has at least a portion having a height that is a multiple of a width thereof greater than 8.

9. The method of claim 1, further comprising heating the build platform.

10. A metal powder additive manufacturing system for creating a metal object, the system comprising:
a build platform to receive successive layers of metal powder and support the metal object during manufacture;
an applicator to create a layer of metal powder over the build platform;
an electron or laser beam transmitter operative to form the metal object layer by layer by selectively melting the successive layers of metal powder over the build platform; and
a control system for controlling an actuator that controls movement between at least the build platform, the electron or laser beam transmitter and the applicator; and
a metal sleeve extending through a slot in the build platform and having an interior surface configured to substantially parallel an outer surface of the metal object as the metal object is formed within the metal sleeve.

11. The system of claim 10, wherein an interior surface of the metal sleeve is spaced apart from the outer surface of the metal object by a distance of greater than 0.1 millimeters and less than 5.0 millimeters.

12. The system of claim 10, wherein the metal sleeve is immovably positioned relative to the applicator.

13. The system of claim 12, wherein the actuator lowers the build platform relative to the applicator.

14. The system of claim 12, wherein the actuator raises at least the applicator relative to the build platform.

15. The system of claim 10, wherein the metal sleeve includes a plurality of metal sleeves having at least one of a different shape, thickness and height.

16. The system of claim 10, further comprising a heater for heating the build platform.

17. The system of claim 10, wherein the metal object has at least a portion having a height that is a multiple of a width thereof greater than 8.

18. A non-transitory computer readable storage medium storing code representative of a metal object and a metal thermal gradient dissipating structure, the metal object and the metal thermal dissipating structure physically generated upon execution of the code by a computerized metal powder additive manufacturing system, the code comprising:
code representing the object and the thermal dissipating structure, the thermal dissipating structure including:
a metal sleeve spaced apart from and substantially paralleling an outer surface of the metal object.

19. The storage medium of claim 18, wherein an interior surface of the metal sleeve is spaced apart from the outer surface of the metal object by a distance of greater than 0.1 millimeters and less than 5.0 millimeters.

20. The storage medium of claim 18, wherein the metal object has at least a portion having a height that is a multiple of a width thereof greater than 8.
